(19) United States
(12) Patent Application Publication
(10) Pub. No.: US 2013/0202314 A1
(43) Pub. Date: Aug. 8, 2013

(54) METHOD FOR TRANSMITTING INFORMATION USING PHOTONS (VARIANTS)

(71) Applicant: German Gadzhiakhmedovich Ramaldanov, Nevinnomyssk (RU)

(72) Inventor: German Gadzhiakhmedovich Ramaldanov, Nevinnomyssk (RU)

(21) Appl. No.: 13/878,829

(22) PCT Filed: Mar. 7, 2012
(86) PCT No.: PCT/RU2012/000165

§ 371 Date: Apr. 11, 2013

(30) Foreign Application Priority Data
Apr. 12, 2011 (RU) 2011114206

(51) Int. Cl. H04B 10/70

(52) U.S. Cl. CPC H04B 10/70
USPC 398/152

(57) ABSTRACT

The invention relates to communications engineering and can be used in the transmission of information remotely on the basis of non-local quantum correlation between quantum particles, some of which are photons. The technical result to which the proposed invention (variants thereof) is directed consists in increasing the reliability of information transmission from a transmitting side to a receiving side of a communications channel. This technical result for the basic variant embodiment of the method for transmitting information using quantum particles is achieved in that, for each particle in a pair emitted by a coherent source of quantum particles, spatial paths, which are directed towards the transmitting and receiving sides, for the propagation of a superimposed state are formed with the possibility of producing mutual interference between the paired particles both on the transmitting and on the receiving side, wherein, corresponding to the binary signal transmitted, modulation on the transmitting side is performed with the aid of a physical action which changes the condition for the propagation of quantum particles in such a way that, in the case of a first value of said signal, there is a disruption to the interference pattern, while in the case of a second value of said signal, the interference pattern is restored on the receiving side, and, on the receiving side, the recovery of information is produced on the basis of the presence or the absence of the interference pattern

The invention refers to communication engineering and may be used while transmitting data to a distance on the basis of non-local quantum correlation between quantum particles, one of these being photons.

It is known the method of data transmission on the basis of the quantum correlation between quantum particles in the entangled quantum-mechanical state. For this purpose, photons are emitted by the use of photon source, directed along a spatial path to the transmitting and receiving sides, distant from the photon source, at the transmitting side the photons are modulated, in accordance with transmitted binary symbols <<1>> and <<0>> and at the receiving side data is allocated. Photons are emitted in pairs in the quantum-mechanical state entangled by polarization, directed to their spatial propagation path of transmitting and receiving side in such a way, that there is non-local quantum correlation between photons of each pair. The data allocation is fulfilled at the receiving side by their interferential pattern (see. RF Pat. No. 2,235,434, c1. H04B 10/30, 2004).

Disadvantages of the known method are low reliability of data transmission from the transmitting side to the receiving side of communication channel.

The technical result, for achievement of which the offered invention (its variants) is designed, is to increase reliability of data transmission from the transmitting side to the receiving side of communication channel.

The given technical result is achieved due to the fact that in the method of data transmission with using quantum particles (as per the first variant) for each particle from the pair emitted by coherent source of paired quantum particle, spatial propagation paths of superposition state, directed to the transmitting and receiving sides, are formed, with possibility to get mutual interference between paired particles, both at the transmitting and receiving sides. At the transmitting side, all spatial propagation paths of paired quantum particles superposition state that arrived to it, are modulated and after that brought in the quantum particles detector, the data is coded and transmitted in the form of binary signals, at that, in accordance with the transmitted binary signal, modulation at the transmitting side is performed using physical influence which change quantum particles propagation conditions in such a way, that at its first value, the interference pattern breaking occurs and at its second value, the interference pattern recovery occurs at the receiving side and data allocation at the receiving side is fulfilled by availability or absence of the interference pattern, at that, propagation paths of quantum particles superposition state are made in such way that the paths from the source to the point of quantum particles detection at the receiving side are longer than from the source to the modulation point at the transmitting side and also due to the fact that the source of paired entangled quantum particles is used as a coherent source of paired quantum particles.

The given technical result is achieved due to the fact that in the method of data transmission with using quantum particles (as per the second variant) for each particle from the pair emitted by coherent source of paired quantum particles, spatial propagation paths of superposition state, directed to the transmitting and receiving sides, are formed, with possibility to get mutual interference between paired particles at the receiving side. At the transmitting side, all propagation spatial paths of paired quantum particles superposition state that arrived to it, are modulated, the data is coded and transmitted in the form of binary signals, at that, in accordance with the transmitted binary signal, modulation at the transmitting side is performed using physical influence which change quantum particles propagation conditions in such a way that at its first value the interference pattern breaking occurs and at its second value the interference pattern recovery occurs at the receiving side and data allocation at the receiving side is fulfilled by availability or absence of the interference pattern, at that, propagation paths of quantum particles superposition state are made in such way that the paths from the source to the point of quantum particles detection at the receiving side are longer than from the source to the modulation point at the transmitting side and also due to the fact that the source of paired entangled quantum particles is used as a coherent source of paired quantum particles.

The given technical result is achieved due to the fact that in the method of data transmission with using quantum particles (as per the third variant) for each particle from the pair emitted by coherent source of paired quantum particles spatial propagation paths of superposition state directed to the transmitting and receiving sides, are formed, with possibility to get mutual interference between pair particles at the receiving side. At the transmitting side, one propagation spatial path of paired quantum particles superposition state that arrived to it, is modulated, the data is coded and transmitted in the form of binary signals, at that, in accordance with the transmitted binary signal, modulation at the transmitting side is performed using physical influence which change quantum particles propagation conditions in such a way that at its first value the interference pattern breaking occurs and at its second value the interference pattern recovery occurs at the receiving side and data allocation at the receiving side is fulfilled by availability or absence of the interference pattern, at that, propagation paths of quantum particles superposition state are made in such way, that the paths from the source to the point of quantum particles detection at the receiving side are longer than from the source to the modulation point at the transmitting side and also due to the fact that the source of paired entangled quantum particles is used as a coherent source of paired quantum particles.

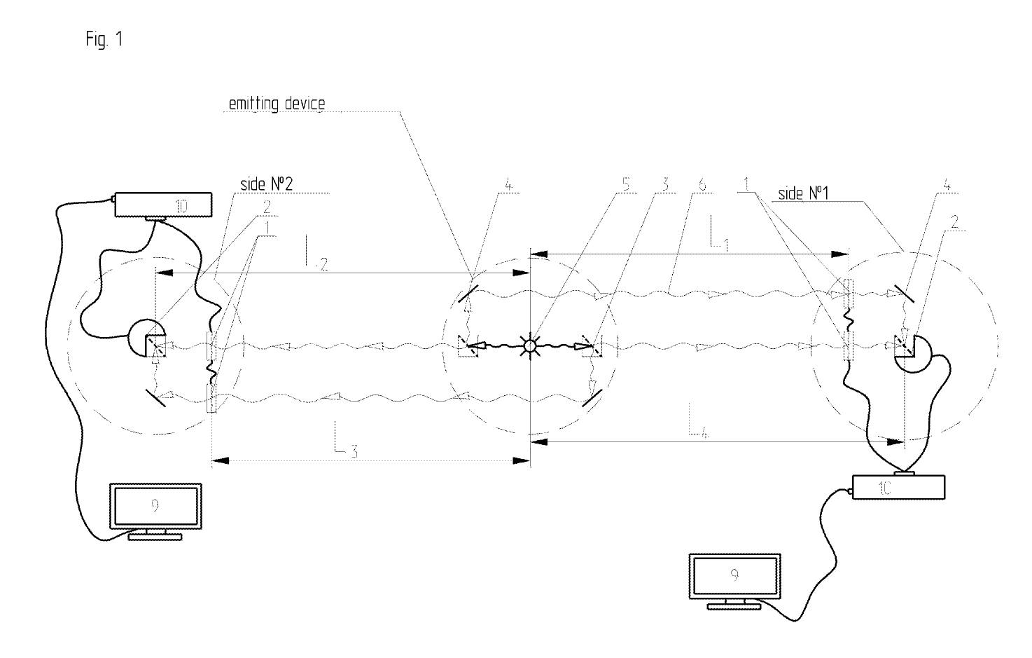

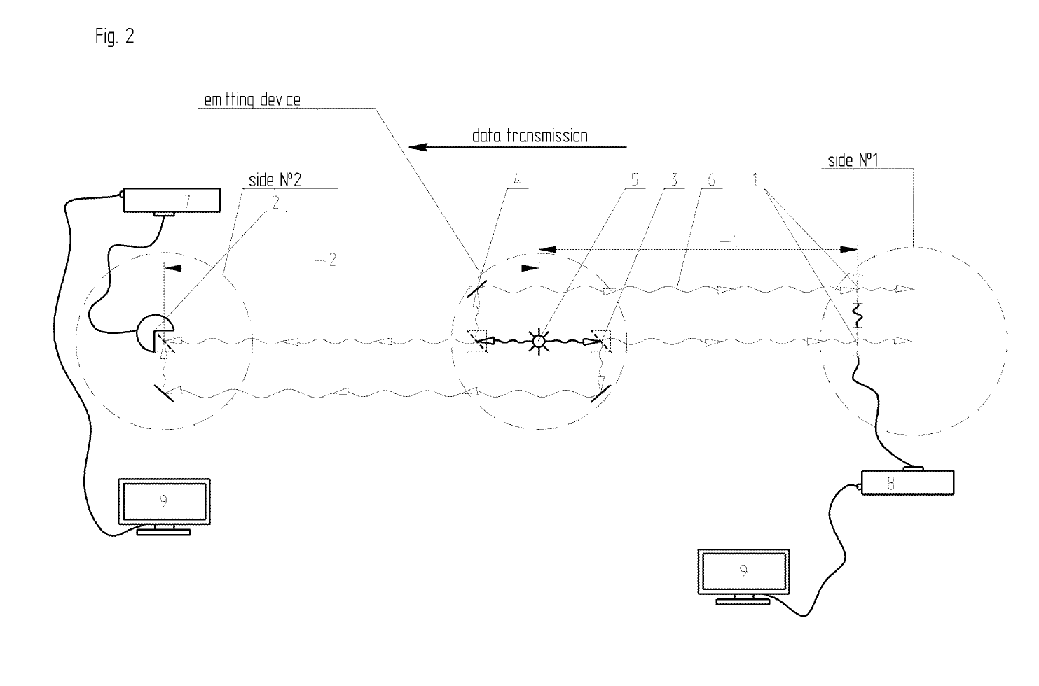

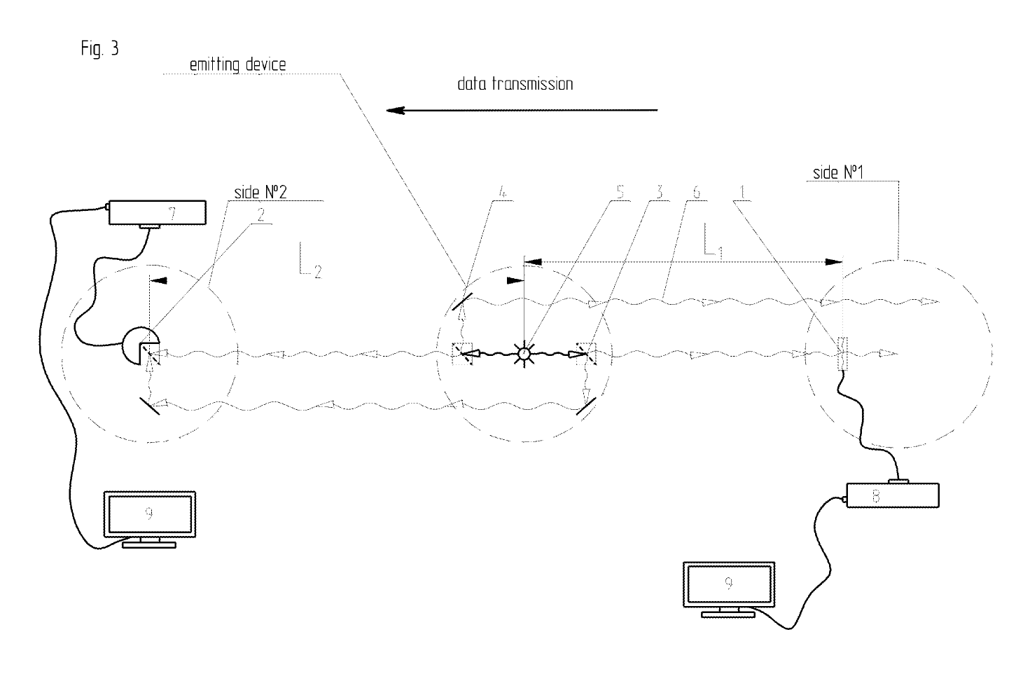

The essence of the invention is illustrated in FIGS. 1-3 and in FIG. 1 it is shown a diagram of the device realizing the method on the first variant with using entangled quantum particles, in basic configuration. In FIG. 2 it is shown a diagram of the device realizing the method on the second variant with using entangled quantum particles without detection by the transmitting side. In FIG. 3 it is shown a diagram of the device realizing the method on the third variant with using entangled quantum particles without detection by the transmitting side and by modulation along one spatial propagation path.

On all figures the following keys are accepted: 1—modulator, 2—detecting device, 3—beam splitter, 4—mirror, 5—source of coherent paired quantum particles (emitter), 6—spatial propagation path of quantum particles superposition state (path), 7—decoder, 8—encoder, 9—monitor (display), 10—encoder-decoder, L₁—distance from the source of coherent paired quantum particles to modulators of side No 1 (arm), L₂—distance from the source of coherent paired quantum particles to detecting device detectors of side No 2 (arm), L₃—distance from the source of coherent paired quantum particles to modulators of side No 2 (arm), L₄—distance from the source of coherent paired quantum particles to detecting device detectors of side No 1 (arm).

Recently numerous reports of experiments with entangled quantum particles (photons) have been published. Such entanglement has been predicted by quantum mechanics since 1920.

In 1935 Einstein, Podolsky and Rosen wrote an article (Einstein A., Podolsky B., Rosen N., <<Can Quantum-Mechanical Description of Physical Reality Be Considered Complete?>>, Phys. Rev. 47, 777, 1935) in which they casted doubt on truth of entanglement conception ensuing from theory and assumed existence of “hidden variable” for explanation of entanglement. In 1962 r. J. S. Bell (Bell J. S., <<Speakable and Unspeakable in Quantum Mechanics>>, New York, Cambridge University Press, 1993) mathematically demonstrated that experiments could show the truth of quantum mechanics predictions. Further, in 1980 A. Aspect (Aspect A., <<Trois tests expérimentaux des inégalités de Bell par mesure de correlation de polarisation de photons>>, Doctoral Dissertation, Université Paris-Orsay, ler Février 1983), using Bell criterion, experimentally showed that the photons entanglement phenomenon is subjected to the quantum mechanics rules.

Within the period of 1990-2000 years some experimenters showed that entangled photons generated by non-linear crystals could remain entangled at a distance up to 10 km (see Townsend P. D., Rarity J. G., Tapster P. R., <<Single-Photon Interference in 10 km Long Optical-Fiber>>, Electronics Letters, V 29, p. 634, 1993). The latest experiments showed possibility of entangled state transmission via satellite to a distance of 144 km (R. Ursin et al., “Space-Quest, Experiments with Quantum Entanglement in Space,” EuroPhysics News, DOI: 10.1051/epn/2009503).

The essence of the physical effect was that the momentary breakage of entangled state, caused by measuring the polarization of one of the photons, led to immediate fixation of another photon polarization in accordance with quantum mechanics laws. Also, teleportation experiments were carried out, in which one photon could be reproduced during transportation with the use of entangled photon pair (see Bennett C. H., et al., “Teleporting an Unknown Quantum State via Dual Classical and EPR Channels”, Phys. Rev. Lett. vol. 70, pp 1895-1899, 1993).

At that, entanglement swapping, which consists in entanglement transmission from one particle ensamble to another, was theoretically studied (Bouda J., and Buzek V., “Entanglement swapping between multi-qubit systems” J.Phys. A: Math. Gen. 34, 4301-4311, 2001) and demonstrated experimentally (de Riedmatten H., et al., “Long-distance entanglement swapping with photons from separated sources”, Phys. Rev., A71, 050302, 2005).

At the present time it is considered, that impossibility of data transmission through entangled states was caused by the fact that entangled states themselves give symmetrical probability observation pattern of measured polarization. In other words, polarization probability of quantum particle (photon) upwards is 50% as well as downwards also—50%.

In such conditions it was impossible to allocate data through measurements at the transmitting side by the receiving side.

Possibility of data transmission appears in that case when quantum effect of entangled states is integrated with the effect of wave function collapse, in such a variant of implementation there appears a possibility at the receiving side to allocate data through the observation of interference pattern (see, for example, the invention description as per RF Pat. No. 2,235,434, cl. H04B 10/30, 2004).

The experiments show that quantum particle (photon) polarization measurements lead to collapsing of photon wave function, which in turn predetermines its behaviour at the moment of interference observation. In this case interference disappears (J. Baldzuhn, E. Mohler, and W. Martienssen. A wave-particle delayed-choice experiment with a single-photon state. Zeitschrift fuer Physik B Condensed Matter, 77(2):347-352, June 1989).

In the given technical solution it is supposed to use for data transmission, along with quantum effect of entangled states, also the wave function collapse effect. With the use of the wave function collapse effect it is supposed to get an opportunity to influence the interference pattern at the receiving side in such a way that the statistic data of quantum particles (photons) detection will be uniquely interpreted by decoding devices as logical <<1>> or <<0>>.

Thus, the supposed method is based on experimentally confirmed and studied phenomena of entangled particles quantum non-locality and the effect of wave function momentary collapse (von Neumann reduction), well-known in quantum mechanics. At that, the supposed technical solution (variants) is configured in such a way, that the central place is taken by emitter which emits quantum particles in opposite sides (paths) in the form of paired entangled particles.

The realization of the suggested method for all variants is based on using the principle of <<cross superposition>>. <<Cross superposition>> is the creation in a physical medium of such conditions, when quantum particles appear in the state of spatial superposition with the possibility to interfere with each other at the opposite ends of propagation paths. In other words, it is such distribution of propagation paths of quantum particles superposition state in space, at which two paths from two different particles move in one direction. It is achieved due to the fact that in the emitting device one particle splits off to move along different paths, and these paths (in this case two paths) are directed in opposite sides. The same action occurs to the paired particle. Thus, two propagation paths of superimposed state from two different particles (two <<halves>> from two different particles) are formed at the transmitting and receiving sides.

The given method is realized in the following way. After coming out from the source of coherent paired quantum particles (of the remitter) 5 (see FIG. 1) quantum particles (photons) at once get into beam splitters 3, then, if necessary, to the mirrors 4, and further, in the form of parallel paired spatial propagation paths of superimposed state 6, they move in free space or via communication mediums (for instance, optical fibre) to the recipients—side No 1 and side No 2. After quantum particles pass a certain distance L₁ on transmitting arm (side (No 1), which should necessarily be slightly shorter (asymmetric) than the receiving arm L₂ (side No 2), the modulators 1 are mounted, connected with encoder 8. At that, modulators 1 take or do not take (depending on the coding signal) measurement of the state of spatial propagation paths of paired quantum particles superposition states 6. Further, the paths 6 necessarily converge in the detecting device 2 of the receiving side and not necessarily (depending on the variant) - at the transmitting side. After getting into detecting device 2 the signal from it arrives at the encoder-decoder 10 and then arrives at the monitor 9 in the user-friendly data form. The given sequence, when observing L₁<L₂, provides data transmission from side No 1 to side No 2. When observing the condition L₃<L₄, and also under availability of coordinated serial data transmission protocol, it becomes possible to transmit data via the same communication channels from side No 2 to side No 1.

Step by step realization of this method, taking into account its different variants, provides for series response of device different parts, shown in FIG. 1-3.

Within the range of the device emitting part the following occurs:

step 1—using the source of coherent paired quantum particles 5, at one instant of time we get a pair of quantum particles (photons);

step 2—using two beam splitters 3 we split off each particle into two spatial propagation paths of superposition state 6, in other words, into two <<half-waves>>;

step 3—with the use of mirrors 4 we make crossing of superposition state propagation paths from different quantum particles according to the <<cross superposition>> principle as shown on FIG. 1;

step 4—we send the crossed <<half-waves>> from different particles to the opposite sides (side No 1 and side No 2);

In free space:

step 5—<<half-waves>> of quantum particles (photons) move, one pair of crossed <<half-waves>> to the transmitting side, another—to the receiving side;

step 6—the pair of <<half-waves>> flying to the transmitting side comes first;

Within the limits of the device transmitting side the following occurs:

step 7—pair of <<half-waves>> reaches modulator 1 (any measuring device, in particular Pockels cell or Faraday cell);

step 8—in modulator 1, depending on the signal which should be transmitted, we perform measurement event, let us assume it is <<1>> in binary coding (in the form of binary signal), or do not perform measurement event—then it is <<0>>;

step 9—then we bring together spatial paths 6 in the detecting device 2.

Within the limits of the device receiving side the following occurs:

step 10—<<half-waves>>, flying to the receiving side from paired quantum particles, reach the detecting device 2, by that moment they already carry the data specified by modulator 1;

step 11—registration of arriving particles occurs in the detecting device 2;

step 12—we send signals from the detecting device 2 to the encoder-decoder 10, decode them and display at the user monitor 9.

It is necessary to take notice of the fact that the detecting device 2 registers quantum particles (photons) hitting one or another detector screen area. In that case, when nothing was done with the propagation paths of paired quantum particles (photons) superposition state at the transmitting side, the waves (wave functions) of quantum particles (photons) successfully reached the screen. Interacting with each other, they form interference pattern in the form of fringes, i.e., form conditions for hitting certain screen areas of the detecting device 2 by separate photons. In another case, when measurement was performed at the transmitting side, due to <<cross superposition>>, the wave functions of quantum particles involved in the measurement event, collapse, both at the transmitting and at the receiving sides. In this case interference vanishes, and photons at the receiving side will be hitting another screen area of the detecting device. In the decoding device 7 statistical processing of quantum particles (photons) hitting one or another screen area is carried out, at that, the result is interpreted as registration of one of two signals either of logical <<1>> or logical <<0>>.

Really, if two quantum particles (photons) arrive to the receiving side, each is in the spatial superposition state (<<half-wave>>), and all necessary conditions are created for them for interference initiation between them, they necessarily, as per the quantum physics laws, in 100% cases out of 100 possible ones, should interfere. This will be shown in the form of separate photons hitting definite areas of the detector screen. Also, it is evident that if measurement is taken even on one spatial propagation path of superposition state at the transmitting side, until a quantum particle arrives to the receiving side, then the quantum particle (photon) will be detected in it with 50% probability, and consequently, at the receiving side, within 50% probability range, the wave function collapses either into empty spatial propagation path of quantum particles superposition state or into the path along which the whole photon propagates. This also completely conforms to quantum physics laws. Namely in those cases, when in one of the two spatial propagation paths of quantum particles superposition state, at the receiving side, as a result of measurements at the transmitting side, absence of photon will be detected and along another one a whole photon will arrive and there will be ‘no one’ for it to interfere with, the interference absence will be detected at the receiving side. Thus, through observations at the receiving side, for availability or absence of interferential pattern at detectors, data transmission will be possible. And in such cases when paired particles preferably will be in the state of entanglement between each other on any of known parameters, the correlation will be increasing between modulating signals at the transmitting side and received statistics at the receiving side. In consequence of this, data transmission rate will be increasing. Besides, in those cases, when paired particles preferably will be in the state of entanglement between each other on one of the known parameters, security from unauthorized access to communication channel will be increasing, since entangled states are unique (inimitable) and are easily identified by legal users.

The first method of data transmission using quantum particles (see FIG. 1) is performed in the following way.

Coherent quantum particles, emitted by source 5, by means of beam splitters 3 and mirrors 4, are directed to the transmitting and receiving sides by spatial paths 6 with possibility to form quantum superposition of two states. The sides are separated from each other in such a way that the distance from source 5 to the location of detecting devices 2 of the receiving side is more than to the location of modulators 1 of the transmitting side. At the transmitting side, spatial propagation paths of paired quantum particles (photons) superposition state 6 are modulated in accordance with transmitted binary signals with which the data being transmitted is coded and the given paths 6 are brought at the transmitting side in detecting device 2 for their registration and for the purpose of displaying the data being transmitted at the monitor 9. The data is coded in the encoders-decoders 10, and from them the control signal arrives to modulators 1 of the transmitting side. The data is transmitted in the form of binary signals. In accordance with transmitted binary signal, the modulation at the transmitting side is made by means of physical influence on modulator 1. Modulator 1 changes quantum particles propagation conditions in such a way that, with a certain probability, this leads, in case if it is turned on, to the interference pattern breaking and in case of inactivity—to the interference pattern recovery at the receiving side. Data allocation at the receiving side is made by availability or absence of the interference pattern at the detecting device 2 of the receiving side. From the detecting device 2 signals arrive to encoder-decoder 10 of the receiving side and further to the user monitor 9. The first variant of the data transmission method with using quantum particles, in case of observance L₁<L₂, provides for the data transmission from side 1 to side 2. Under observance condition L₃<L₄, and also in case of availability of agreed data transmission serial protocol it becomes possible to transmit data, along the same communication channels, from side 2 to side 1.

Entangled quantum particles (photons) emitted in pairs and also simultaneously emitted paired entangled quantum particle groups (photons) may be used as quantum particles (photons).

Let us consider realization of the method given variant by the example 1.

### EXAMPLE 1

### Using Entangled Paired Quantum Particles in Basic Configuration

Coherent quantum particles source 5 emits a pair of entangled quantum particles (photons) in opposite directions. Within the limits of emitting device, each entangled particle gets into its own beam splitter 3, where it comes into quantum superposition of two states (straight movement and sideways movement) and comes out, moving in accordance with superposition of two states, each along its two spatial propagation paths 6.

One of the spatial propagation paths 6 of each quantum particle after beam splitter 3 goes in initial direction, the second one, by means of minor 4 (in case of making propagation spatial paths along free space, for instance, in cases of using optical fibre, there is no need in mirrors) goes in the reverse direction, towards paired particle movement.

After a while, the particles reach the transmitting and receiving sides.

At the transmitting side, some time before quantum particles appear at the receiving side (mandatory operation condition), both spatial propagation paths from two different particles are modulated via modulator 1 (Pockels cell or Faraday cell). A signal is fed (<<zero>> code) or not fed (“one” code) to the Faraday cell in the form of electrical pulse, in consequence of this, measurement event of the particle physical parameter (for example, spin) either occurs at the transmitting side or does not occur. It is allowed to use Pockels cell instead of Faraday cell. Pockels Effect, the same as Faraday Effect, is practically inertialess (response speed about 10⁻¹⁰ s). Owing to this, it enjoys an active application in creation of optical modulators. After passing modulators 1, the particles get into detecting device 2 of the transmitting side for registration of the signal being transmitted.

After a while, at the receiving side, due to operation of modulators 1 at the transmitting side, detecting device 2 registers either absence (in cases of measurement) or presence of interference pattern.

Thus, breaking (wave function collapse) or leaving interference pattern at the receiving side of data recipient, taking measurements at the transmitting side of sender, it becomes possible to transmit data through its <<0>>/<<1>> coding.

Peculiarity of the given variant is its increased security from unauthorized interception and also capability to send data both directions. Under observance L₁<L₂ it provides for data transmission from side 1 to side 2. Under observance of condition L₃<L₄, and also in case of availability of agreed data transmission serial protocol it becomes possible to transmit data along the same communication channels, from side 2 to side 1.

The second method of data transmission using quantum particles (see FIG. 2) is performed in the following way.

Coherent quantum particles, emitted by source 5, by means of beam splitters 3 and mirrors 4, are directed to the transmitting and receiving sides by spatial paths 6 with possibility to form quantum superposition of two states. The sides are separated from each other in such a way that the distance from source 5 to the location of detectors 2 of the receiving side is more than to the location of modulators 1 of the transmitting side. At the transmitting side spatial propagation paths of paired quantum particles (photons) superimposed state 6 are modulated in accordance with transmitted binary signals with which the data being transmitted is coded. The data is coded in encoder 8, from which the control signal arrives to modulators 1 of the transmitting side. The data is transmitted in the form of binary signals. In accordance with the transmitted binary signal, the modulation at the transmitting side is made by means of physical influence on modulator 1. Modulator 1 changes quantum particles propagation conditions in such a way that, with a certain probability, this leads, in case if it is turned on, to the interference pattern breaking and in case of inactivity—to the interference pattern recovery at the receiving side. Data allocation at the receiving side is made by availability or absence of the interference pattern at the detecting device 2 of the receiving side. From the detecting device signals arrive to decoder 7 of the receiving side and further, to the user monitor 9.

Peculiarity of the given variant is its capability to transmit data only in one direction: from the transmitting side to the receiving side.

Let us consider realization of the method given variant by the example 2.

### EXAMPLE 2

### Using Entangled Paired Quantum Particles Without Detection by Transmitting Side

Coherent quantum particles source 5 emits a pair of entangled quantum particles in opposite directions. Within the limits of emitting device, each entangled particle gets into its own beam splitter 3, where it comes into quantum superposition of two states (straight movement and sideways movement) and comes out, moving in accordance with superposition of two states, each along its two spatial propagation paths 6.

One of the spatial propagation paths 6 of each quantum particle after beam splitter 3 goes in initial direction, the second one, by means of mirror 4 (in case of making spatial propagation paths along free space, for instance, in case of using optical fibre, there is no need in mirrors) goes in the reverse direction, towards paired particle movement.

After a while the particles reach the transmitting and receiving sides.

At the transmitting side, some time before quantum particles appear at the receiving side (mandatory operation condition), both propagation spatial paths from two different particles are modulated via modulator 1 (Pockels cell or Faraday cell). A signal is fed (<<zero>> code) or not fed (“one” code) to the Faraday cell in the form of electrical pulse. In consequence of this, measurement event of the particle physical parameter (for example, spin) either occurs on the transmitting side or does not. After a while, at the receiving side, due to operation of modulators 1 at the transmitting side, detecting device 2 registers either absence (in case of measurement) or presence of interference pattern.

Thus, breaking (wave function collapse) or leaving interference pattern at the receiving side of data recipient, taking measurements at the transmitting side of sender, it becomes possible to transmit through its <<0>>/<<1>> coding.

Peculiarity of the given variant is its increased security from unauthorized interception when transmitting data in one direction, from the transmitting side to the receiving side.

The third method of data transmission using quantum particles (see FIG. 3) is performed in the following way.

Quantum particles, emitted by coherent source 5, by means of beam splitters 3 and mirrors 4, are directed to the transmitting and receiving sides by spatial paths 6 with possibility to form quantum superposition of two states. The sides are separated from each other in such a way that the distance from source 5 to the location of detectors 2 of the receiving side is more than to the location of modulators 1 of the transmitting side. At the transmitting side one spatial propagation path of pair quantum particles (photons) superposition state 6 is modulated in accordance with transmitted binary signals with which the data being transmitted is coded. The data is coded in encoder 8, from which the control signal arrives to modulators 1 of the transmitting side. The data is transferred in the form of binary signals. In accordance with the transferred binary signal, the modulation at the transmitting side is made by means of physical influence on modulator 1. Modulator 1 changes quantum particles propagation conditions in such a way that, with a certain probability, this leads, in case if it is turned on, to the interference pattern breaking and in case of inactivity—to the interference pattern recovery at the receiving side. Data allocation at the receiving side is fulfilled by availability or absence of the interference pattern at the detecting device 2 of the receiving side.

From the detecting device 2 signals arrive to decoder 7 of the receiving side and further, to the user monitor 9.

Peculiarity of the given variant is its increased reliability due to simplification of the transmitting side hardware device.

Let us consider realization of the method given variant by the example 3.

### EXAMPLE 3

### Using Entangled Paired Quantum Particles Without Detection by Transmitting Side and by Modulation Along One Spatial Propagation Path

Coherent quantum particles source 5 emits a pair of entangled quantum particles in opposite directions. Within the limits of emitting device each entangled particle gets into its own beam splitter 3, where it comes into quantum superposition of two states (straight movement and sideways movement) and comes out, moving in accordance with superposition of two states, each along its two spatial propagation paths 6.

One of the spatial propagation paths 6 of each quantum particle after beam splitter 3 goes in initial direction, the second one, by means of mirror 4 (in case of laying spatial propagation paths along free space, for instance, in case of using optical fibre, there is no need in mirrors) goes in the reverse direction, towards paired particle movement. After a while, the particles reach the transmitting and receiving sides.

At the transmitting side, some time before quantum particles appear at the receiving side (mandatory operation condition) one spatial propagation path of quantum particle superposition state is modulated via modulator 1 (Pockels cell or Faraday cell). A signal is fed (<<zero>> code) or not fed (“one” code) to the Faraday cell in the form of electrical pulse. In consequence of this, measurement event of the particle physical parameter (for example, spin) either occurs on the transmitting side or does not. After a while, at the receiving side, due to operation of modulators 1 at the transmitting side, detecting device 2 registers either absence (in case of measurement) or presence of interference pattern.

Thus, breaking (wave function collapse) or leaving interference pattern at the receiving side of data recipient, taking measurements at the transmitting side of sender, it becomes possible to transmit data through its <<0>>/<<1>> coding.

Peculiarity of the given variant is its increased security from unauthorized interception, at simplification of the transmitting side hardware device.

By all appearances, there are other variants of offered quantum communication based on the principle described above. However, they may differ by configuration of devices which realize an actual method variant.

Using the offered invention allows to increase data transmission reliability from the transmitting side to the receiving side of communication channel.

1.-6. (canceled)

7. A data transmission method using quantum particles, wherein for each particle from a pair emitted by a coherent source of quantum paired particles, spatial propagation paths of a superposition state are formed and directed to transmitting and receiving sides, with a possibility to get mutual interference between paired particles, both at the transmitting side and at the receiving side, wherein at the transmitting side, all spatial propagation paths of paired quantum particles superposition state that arrive to it are modulated, and after that, brought in a quantum particle detector, wherein data is coded and sent in the form of a binary signal, wherein in accordance with the transmitted binary signal, modulation at the transmitting side is performed using a physical influence that changes a quantum particle propagation condition in such a way that, at its first value, an interference pattern breaking occurs, and at its second value, an interference pattern recovery occurs at the receiving side, wherein data allocation at the receiving side is fulfilled by availability or absence of the interference pattern and propagation paths of a quantum particle superposition state are made in such way that the paths from the source to the point of quantum particle detection at the receiving side are longer than from a source to a modulation point at the transmitting side.

8. The method according to claim 7, wherein a source of paired entangled quantum particles is used as a coherent source of paired quantum particles.

9. A data transmission method using quantum particles, wherein for each particle from a pair emitted by a coherent source of quantum paired particles, spatial propagation paths of a superposition state are formed and directed to a transmitting and a receiving side, with a possibility to get mutual interference between paired particles at the receiving side, at the transmitting side, all spatial propagation paths of paired quantum particles superposition state that arrive to it, are modulated, wherein data is coded and sent in the form of binary signals, wherein in accordance with the transmitted binary signal, modulation at the transmitting side is performed using a physical influence that changes a quantum particles propagation condition in such a way that, at its first value, an interference pattern breaking occurs and, at its second value, an interference pattern recovery occurs at the receiving side, wherein data allocation at the receiving side is fulfilled by availability or absence of the interference pattern and propagation paths of the quantum particles superposition state are made in such way that the paths from the source to a point of quantum particles detection at the receiving side are longer than from a source to a modulation point at the transmitting side.

10. The method according to claim 9, wherein a source of paired entangled quantum particles is used as a coherent source of paired quantum particles.

11. A data transmission method using quantum particles, wherein for each particle from a pair emitted by a coherent quantum paired particle source, spatial propagation paths of superposition state are formed and directed to transmitting and receiving sides, with a possibility to get mutual interference between paired particles at the receiving side, at the transmitting side, one spatial propagation path of paired quantum particles superposition state that arrived to it, is modulated, wherein the data is coded and sent in the form of a binary signal, wherein in accordance with the transferred binary signal, modulation at the transmitting side is performed using a physical influence that changes a quantum particles propagation condition in such a way that, at its first value, an interference pattern breaking occurs and, at its second value, an interference pattern recovery occurs at the receiving side, wherein data allocation at the receiving side is fulfilled by availability or absence of the interference pattern and propagation path of the quantum particle superposition state are made in such way that the paths from the source to a point of a quantum particle detection at the receiving side are longer than from a source to a modulation point at the transmitting side.

12. The method according to claim 11, wherein a source of paired entangled quantum particles is used as a coherent source of paired quantum particles.
